(19) United States
(12) Patent Application Publication
(10) Pub. No.: US 2002/0038995 A1
(43) Pub. Date: Apr. 4, 2002

(54) Shadow mask assembly for color cathode-ray tube having high color purity

(75) Inventor: Soshi Fukao, Tokyo (JP)

Correspondence Address: SUGHRUE, MION ZINN MACPEAK & SEAS, 2100 Pennsylvania Avenue, N.W., Washington, DC, 20037, US

(73) Assignee: NEC CORPORATION

(21) Appl. No.: 09/961,759

(22) Filed: Sep. 25, 2001

(30) Foreign Application Priority Data
Oct. 3, 2000 (JP) 2000-303487

(51) Int. Cl. H01J 29/02; H01J 29/82

(52) U.S. Cl. 313/407

(57) ABSTRACT

A shadow mask assembly for color cathode-ray tube comprises a mask frame which has a rectangular frame like shape and which is composed of a pair of short side mask frame members and a pair of long side mask frame members. Each of the short side mask frame members has a bimetal structure which bends according to variations in temperature. A shadow mask having a rectangular shape is attached to the long side mask frame members. When temperature rises, the short side mask frame members bend toward a direction in which an increase in the tension of the shadow mask is cancelled and, when temperature falls, the short side mask frame members bend toward another direction in which a decrease in the tension of the shadow mask is cancelled. Therefore, the tension of the shadow mask does not vary and the shadow mask does not deform from the original cylindrical surface. Thus, the Q-value is kept constant, and color purity does not deteriorate.

### FIELD OF THE INVENTION

The present invention relates generally to a shadow mask assembly for a color cathode-ray tube (or Braun tube). More particularly, the present invention relates to a shadow mask assembly or a shadow mask structural assembly in which deformation of a shadow mask due to variations in temperature can be effectively avoided and by which high color purity in a color cathode-ray tube can be realized.

### BACKGROUND OF THE INVENTION

Recently, a color cathode-ray tube having a flat glass panel surface has become widely used. Such color cathode-ray tube is called a flat panel color cathode-ray tube. In the flat panel color cathode-ray tube, however, an inner surface of the glass panel is not a flat surface but is a cylindrical surface. One reason for this is that, if the thickness of the glass panel is uniform, the withstanding pressure of the glass bulb including such glass panel becomes low and there is a possibility that the glass bulb implodes. Another reason for this is that, if the thickness of the glass panel is uniform, an image displayed by such color cathode-ray tube looks concave and unnatural. That is, in order to avoid the implosion of the glass bulb and to obtain naturally flat image, the inner surface of the glass panel is made cylindrical and the glass panel is made thinner at the middle portion and thicker at the peripheral portions.

A distance between the inner surface of the glass panel and the shadow mask is generally called a Q-value. In order to keep the Q-value approximately constant throughout the glass panel, the shadow mask also has a cylindrical surface having a radius which is approximately the same as that of the inner surface of the glass panel.

FIG. 7 is a perspective view showing an example of a conventional shadow mask assembly 40 for a 19 inch type flat color cathode-ray tube. Approximate sizes of the shadow mask assembly 40 are as follows. That is, a long side is 360 mm in length, a short side is 270 mm in length, and the height is 40 mm. As shown in FIG. 7, a mask frame 41 has an approximately rectangular frame like shape, and is composed of a pair of short side mask frame members 41B and a pair of long side mask frame members 41A mutually coupled, for example, by welding. Each of the short side mask frame members 41B and the long side mask frame members 41A is an elongated member having an L-shaped cross section. Each of the long side mask frame members 41A has an upper edge portion having an arc shape.

A shadow mask 42 having approximately a rectangular shape is attached onto the mask frame 41. That is, as shown in FIG. 7, long sides 42A of the shadow mask 42 are seam-welded onto upper edge portions 41A of the long side mask frame members 41A, i.e., onto the portions having arc shape. In FIG. 7, in order to clearly show an inner structure of the mask frame 41, the shadow mask 42 is depicted only by using two dot chain lines showing long sides 42A, short sides 42B and border line 42C between an area 42D in which holes or apertures are formed and a peripheral area 42E of the shadow mask 42.

When the long sides 42A of the shadow mask are welded onto the upper edge surfaces of the long side mask frame members 41A, the long side mask frame members 41A are resiliently deformed inside, that is, toward each other. Therefore, after welding the shadow mask 42 on the long side mask frame members 41A, predetermined tension is always exerted on the shadow mask 42 in the direction X-X′ shown in FIG. 7. The upper edge portion of each of the long side mask frame members 42A has an arc shape, and, therefore, the shadow mask 42 forms a cylindrical surface.

The shadow mask 42 and the long side mask frame members 41A are made of Invar (trademark) alloy. The short side mask frame members 41B are made of 13 chromium stainless steel. The reason why the long side mask frame members 41A are made of expensive Invar alloy is that, by matching the thermal expansion coefficient of the long side mask frame members 41A with that of the shadow mask 42, deformation of the shadow mask 42 can be avoided when the mask frame 41 is thermally expanded.

When the color cathode-ray tube is in use, more than 50 percent of the accelerated electron beams collide with the shadow mask 42 and, therefore, the temperature of the shadow mask assembly rises approximately to 60 degrees Celsius. The thermal expansion coefficient of Invar alloy is approximately 1.2 ppm/° C. and the thermal expansion coefficient of 13 chromium stainless steel is approximately 12 ppm/° C. That is, the thermal expansion coefficient of the short side mask frame members is approximately ten times larger than the thermal expansion coefficient of the shadow mask. Therefore, the shadow mask deformation occurs as mentioned below.

FIG. 8 schematically illustrates such deformation of the mask frame 41 and of the shadow mask 42 when the temperature of the conventional shadow mask assembly 40 rises from 25 degrees Celsius to 60 degree Celsius. In these drawings, solid lines show shapes of the mask frame 41 and the shadow mask 42 at a temperature of 25° C. and two dot chain lines show shapes of the mask frame 41 and the shadow mask 42 at a temperature of 60° C. As shown in FIG. 8, the short side mask frame members 41B expands from the shape shown by the solid line to the shape shown by the two dot chain lines when the temperature changes from 25° C. to 60° C. As a result thereof, at a temperature of 60° C., the tension of the shadow mask 42 increases from the tension at 25° C., and therefore the shadow mask 42 deforms from the original cylindrical surface shown by the solid line toward flatter surface shown by the two dot chain lines. That is, the middle portion of the cylindrical surface of the shadow mask 42 becomes slightly sagged or caved in as shown by the two dot chain line. The quantity of the dent becomes approximately 100 μm at the center of the shadow mask 42. That is, the Q-value increases throughout the image screen and the maximum value of an increase in the Q-value is approximately 100 μm at the center of the image screen. When the Q-value varies, the location of landing of an electron beam onto the inner surface of the glass panel deviates from a predetermined location. The magnitude of the deviation of the landing location varies depending on the location on the glass panel, but the maximum value of the deviation becomes approximately 20 μm. Since the disposition pitch of fluorescent materials applied onto the inner surface of the glass panel is 83 μm, the deviation of 20 μm has a relatively large influence on the color purity and is not negligible.

The deviation of landing location occurs because the thermal expansion coefficient of the short side mask frame members 41B is larger than that of the shadow mask 42. Therefore, if the short side mask frame members 41B are also made of Invar alloy which is the same material as that of the shadow mask 42, the deviation of landing location does not occur. However, when the short side mask frame members 41B are also made of Invar alloy, costs of the mask frame 41 becomes high and, therefore, such structure is not desirable.

### SUMMARY OF THE INVENTION

Therefore, it is an object of the present invention to provide a shadow mask assembly in which deformation of a shadow mask can be effectively avoided regardless of variations in temperature.

It is still another object of the present invention to provide a shadow mask assembly in which tension of a shadow mask can be kept uniform regardless of variations in temperature.

It is still another object of the present invention to provide a shadow mask assembly which is low-cost and in which deformation of the shadow mask can be effectively avoided regardless of variations in temperature.

It is still another object of the present invention to provide a shadow mask assembly by which deviation of landing location of electron beam in a color cathode-ray tube can be effectively avoided regardless of variations in temperature.

It is still another object of the present invention to provide a color cathode-ray tube in which high color purity can be maintained regardless of variations in temperature.

It is still another object of the present invention to provide a color cathode-ray tube which is low-cost and in which high color purity can be maintained regardless of variations in temperature.

It is still another object of the present invention to obviate the disadvantages of the conventional shadow mask assembly and the conventional color cathode-ray tube using the same.

In order to solve the above-mentioned problems of the conventional shadow mask assembly, the shadow mask assembly according to the present invention comprises short side mask frame members each having a bimetal structure which bends depending on variations in temperature. The direction of bend of the short side mask frame members is selected such that an increase in the tension of the shadow mask is canceled when a temperature rises and such that a decrease in the tension of the shadow mask is canceled when a temperature falls.

To realize the bimetal structure of the short side mask frame members which bends as mentioned above, it is possible, for example, to attach or stick a metal member having a thermal expansion coefficient smaller than that of the short side mask frame members on the upper side, that is, on the side of the shadow mask, of each of the short side mask frame members. It is also possible to attach or stick a metal member having a thermal expansion coefficient larger than that of the short side mask frame members on the lower side of each of the short side mask frame members.

By using such structure, even if the temperature rises and the short side mask frame members expand thereby, the tension of the shadow mask does not vary and therefore the shadow mask does not deform from the original cylindrical surface. On the other hand, when the ambient temperature is relatively low, for example, when the color cathode-ray tube is used in the cold latitudes, even if the temperature of the shadow mask assembly becomes relatively low, the tension of the shadow mask of the shadow mask assembly according to the present invention is substantially the same as before. As a result thereof, the Q-value is kept constant, and color purity does not deteriorate.

As another structure, it is possible to attach mask support members onto the long side mask frame members and to weld the shadow mask onto the mask support members not onto the long side mask frame members. By using such structure, it is not necessary to match the thermal expansion coefficient of the long side mask frame members with that of the shadow mask. Therefore, it becomes possible to make the long side mask frame members by using cheap material, such as 13 chromium stainless steel, which is used as material of the short side mask frame members. It is preferable to match the thermal expansion coefficient of the mask support members with that of the shadow mask. Thereby, when temperature of the shadow mask assembly varies, unnecessary deformation or distortion of the shadow mask does not occur.

According to an aspect of the present invention, there is provided a shadow mask assembly comprising: a mask frame which has a rectangular frame like shape and which is composed of a pair of short side mask frame members each having a bimetal structure which bends according to variations in temperature, and a pair of long side mask frame members; and a shadow mask which has a rectangular shape and whose long sides are fixed to the mask frame; wherein, when temperature rises, the short side mask frame members bend toward a direction in which an increase in the tension of the shadow mask is cancelled and, when temperature falls, the short side mask frame members bend toward another direction in which a decrease in the tension of the shadow mask is cancelled.

In this case, it is preferable that each of the short side mask frame members comprises an elongated member and a band shaped member which is attached onto the elongated member on the side of the shadow mask and which has a thermal expansion coefficient smaller than that of the elongated member.

It is also preferable that the short side mask frame members are made of 13 chromium stainless steel.

It is further preferable that the band shaped member is made of Invar alloy.

It is advantageous that each of the short side mask frame members comprises an elongated member and a band shaped member which is attached onto the elongated member on the side opposite to the shadow mask and which has a thermal expansion coefficient larger than that of the elongated member.

It is also advantageous that the short side mask frame members are made of 13 chromium stainless steel.

It is further advantageous that the band shaped member is made of 18-8 stainless steel.

It is preferable that thermal expansion coefficient of the long side mask frame members is substantially equal to that of the shadow mask.

It is also preferable that the shadow mask and the long side mask frame members are made of Invar alloy.

According to another aspect of the present invention, there is provided a shadow mask assembly comprising: a mask frame which has a rectangular frame like shape and which is composed of a pair of short side mask frame members each having a bimetal structure which bends according to variations in temperature, and a pair of long side mask frame members each including an elongated member and a mask support member attached to the elongated member; and a shadow mask which has a rectangular shape and whose long sides are fixed to the mask support members; wherein, when temperature rises, the short side mask frame members bend toward a direction in which an increase in the tension of the shadow mask is cancelled and, when temperature falls, the short side mask frame members bend toward another direction in which a decrease in the tension of the shadow mask is cancelled.

In this case, it is preferable that each of the short side mask frame members comprises an elongated member and a band shaped member which is attached onto the elongated member on the side of the shadow mask and which has a thermal expansion coefficient smaller than that of the elongated member.

It is also preferable that each of the short side mask frame members comprises an elongated member and a band shaped member which is attached onto the elongated member on the side opposite to the shadow mask and which has a thermal expansion coefficient larger than that of the elongated member.

It is further preferable that thermal expansion coefficient of the mask support members is substantially equal to that of the shadow mask.

It is advantageous that the shadow mask and the mask support members are made of Invar alloy.

It is also advantageous that the short side mask frame members and the long side mask frame members are made of 13 chromium stainless steel.

It is further advantageous that each of the mask support members is attached to the corresponding one of the long side mask frame members at the central portion of the mask support member.

According to still another aspect of the present invention, there is provided a color cathode-ray tube including a shadow mask assembly comprising: a mask frame which has a rectangular frame like shape and which is composed of a pair of short side mask frame members each having a bimetal structure which bends according to variations in temperature, and a pair of long side mask frame members; and a shadow mask which has a rectangular shape and whose long sides are fixed to the mask frame; wherein, when temperature rises, the short side mask frame members, bend toward a direction in which an increase in the tension of the shadow mask is cancelled and, when temperature falls, the short side mask frame members bend toward another direction in which a decrease in the tension of the shadow mask is cancelled.

According to still another aspect of the present invention, there is provided a color cathode-ray tube including a shadow mask assembly comprising: a mask frame which has a rectangular frame like shape and which is composed of a pair of short side mask frame members each having a bimetal structure which bends according to variations in temperature, and a pair of long side mask frame members each including an elongated member and a mask support member attached to the elongated member; and a shadow mask which has a rectangular shape and whose long sides are fixed to the mask support members; wherein, when temperature rises, the short side mask frame members bend toward a direction in which an increase in the tension of the shadow mask is cancelled and, when temperature falls, the short side mask frame members bend toward another direction in which a decrease in the tension of the shadow mask is cancelled.

### BRIEF DESCRIPTION OF THE DRAWINGS

These and other features, and advantages, of the present invention will be more clearly understood from the following detailed description taken in conjunction with the accompanying drawings, in which like reference numerals designate identical or corresponding parts throughout the figures, and in which:

FIG. 1 is a perspective view showing a structure of a shadow mask assembly according to the first embodiment of the present invention;

FIG. 2A shows a left side view and a front view of the shadow mask assembly of FIG. 1 at a temperature of 25 degrees Celsius;

FIG. 2B shows a left side view and a front view of the shadow mask assembly of FIG. 1 at a temperature of 60 degrees Celsius;

FIG. 3 is a perspective view showing a structure of a shadow mask assembly according to the second embodiment of the present invention

FIG. 4A shows a left side view and a front view of the shadow mask assembly of FIG. 3 at a temperature of 25 degrees Celsius;

FIG. 4B shows a left side view and a front view of the shadow mask assembly of FIG. 3 at a temperature of 60 degrees Celsius;

FIG. 5 is a perspective view showing a structure of a shadow mask assembly according to the third embodiment of the present invention;

FIG. 6A shows a left side view and a front view of the shadow mask assembly of FIG. 5 at a temperature of 25 degrees Celsius;

FIG. 6B shows a left side view and a front view of the shadow mask assembly of FIG. 5 at a temperature of 60 degrees Celsius;

FIG. 7 is a perspective view showing an example of a conventional shadow mask assembly for a 19 inch type flat color cathode-ray tube; and

FIG. 8 includes a left side view and a front view of the conventional shadow mask assembly of FIG. 7, and shows deformation of the conventional shadow mask assembly when the temperature rises from 25 degrees Celsius to 60 degree Celsius.

### DESCRIPTION OF A PREFERRED EMBODIMENT

With reference to the drawings, embodiments of the present invention will now be described in detail.

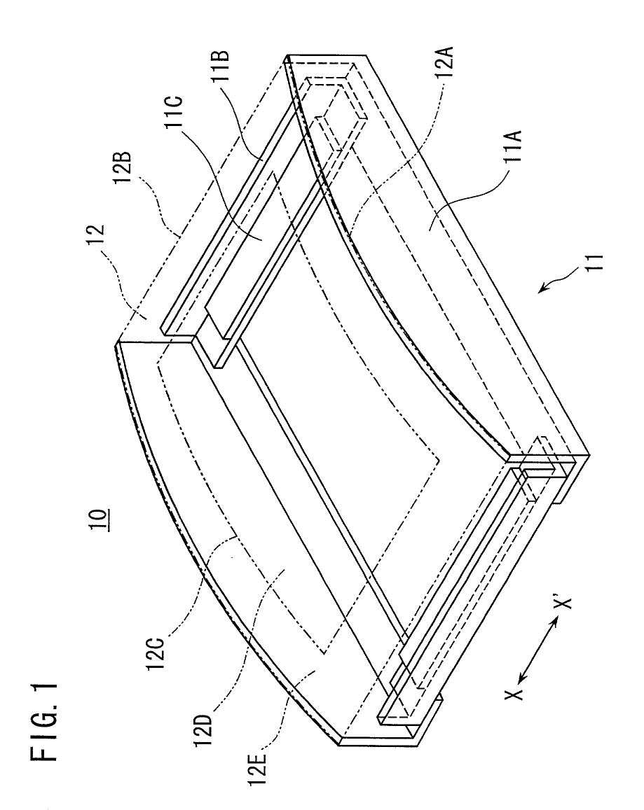

FIG. 1 is a perspective view showing a structure of a shadow mask assembly 10 according to the first embodiment of the present invention. The shadow mask assembly 10 according to the first embodiment of the present invention is for use in a 19 inch type flat color cathode-ray tube. Approximate sizes of the shadow mask assembly 10 are as follows. That is, a long side is 360 mm in length, a short side is 270 mm in length, and the height is 40 mm. As shown in FIG. 1, a mask frame 11 has an approximately rectangular frame like shape, and is composed of a pair of short side mask frame members 11B and a pair of long side mask frame members 11A mutually coupled by welding and the like. Each of the short side mask frame members 11B and the long side mask frame members 11A is an elongated member having, for example, an L-shaped cross section as shown in FIG. 1. Each of the long side mask frame members 11A has an upper edge portion having an arc shape.

A shadow mask 12 having approximately a rectangular shape is attached onto the mask frame 11. That is, as shown in FIG. 1, long sides 12A of the shadow mask 12 are seam-welded onto upper edge portions of the long side mask frame members 11A, i.e., onto the portions having arc shape. In FIG. 1, in order to clearly show an inner structure of the mask frame 11, the shadow mask 12 is depicted only by using two dot chain lines showing long sides 12A, short sides 12B and border line 12C between an area 12D in which holes or apertures are formed and a peripheral area 12E of the shadow mask 12.

When the long sides 12A of the shadow mask 12 are welded onto the upper edge surfaces of the long side mask frame members 11A, the long side mask frame members 11A are resiliently deformed inside, that is, toward each other. Therefore, after welding the shadow mask 12 on the long side mask frame members 11A, predetermined tension is always exerted onto the shadow mask 12 in the direction X-X′ shown in FIG. 1. The upper edge portion of each of the long side mask frame members 11A has an arc shape, and, therefore, the shadow mask 12 forms a cylindrical surface.

The shadow mask 12 is made, for example, of Invar alloy and is 100 μm in thickness. Each of the long side mask frame members 11A is also made of Invar alloy, and is an elongated member which has an L-shaped cross section and which is 2.2 mm in thickness. Each of the short side mask frame members 11B is made of 13 chromium stainless steel, and is an elongated member which has an L-shaped cross section and which is 2.2 mm in thickness.

The first embodiment of the present invention is characterized in that a band shaped member 11C made, for example, of Invar alloy having a thermal expansion coefficient smaller than that of 13 chromium stainless steel is attached or stuck on the upper side, that is, on the side of the shadow mask 12, of each of the short side mask frame members 11B.

Thereby, each of the short side mask frame members 11B has a bimetal structure. The band shaped member 11C is attached to the short side mask frame member 11B by using, for example, welding. In this case, it is preferable to weld the band shaped member 11C and the short side mask frame member 11B at at least three points or portions, for example, at both end portions and the central portion of the band shaped member 11C. The sizes of each of the band shaped member 11C is, for example, 2 mm in thickness, 10 mm in width and 180 mm in length. The sizes of the band shaped member 11C can be appropriately selected by experiments.

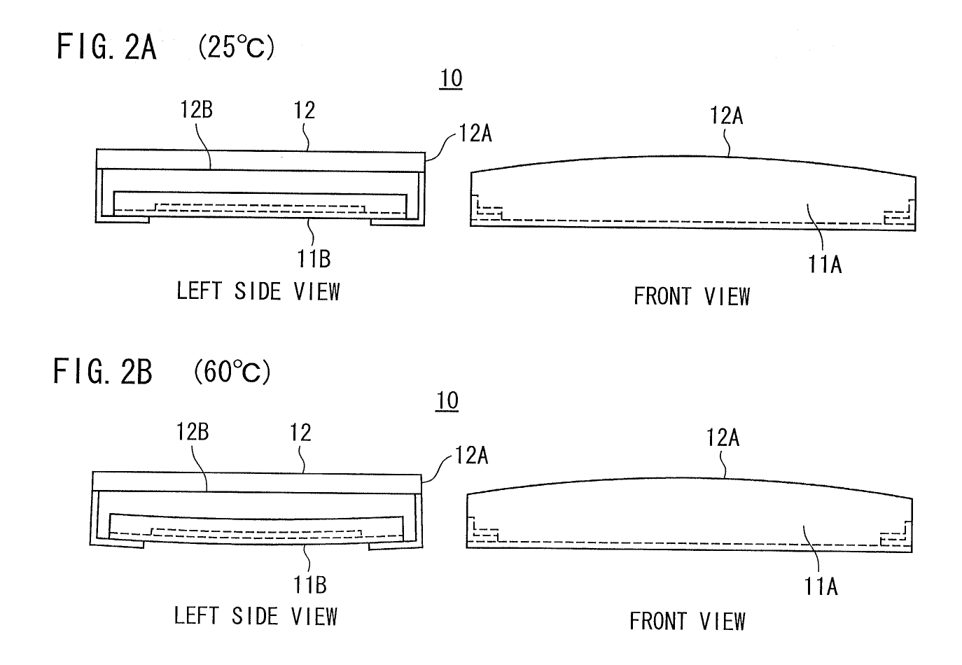

FIG. 2A and FIG. 2B schematically illustrate deformation of the mask frame 11 when the temperature of the shadow mask assembly 10 rises from 25 degrees Celsius to 60 degree Celsius. FIG. 2A shows the mask frame 11 at a temperature of 25° C. and FIG. 2B shows the mask frame 11 at a temperature of 60° C. As shown in FIG. 2A, the short side mask frame members 11B has a straight line shape at a temperature of 25° C. As shown in FIG. 2B, at a temperature of 60° C., the short side mask frame members 11B bends such that the middle portion thereof protrudes downward, because of the bimetal structure of the short side mask frame members 11B. As a result thereof, at a temperature of 60° C., the tension of the shadow mask 12 does not vary from the tension at 25° C., and therefore the shadow mask 12 does not deform from the original cylindrical surface. In the conventional shadow mask assembly, when a temperature rises from 25° C. to 60° C., the short side mask frame members expands in a straight line shape and, therefore, the tension of the shadow mask increases.

On the other hand, when the ambient temperature is relatively low, for example, when the color cathode-ray tube is used in the cold latitudes, if the temperature of the shadow mask assembly has fallen, for example, to 5° C., the tension of the shadow mask of the conventional shadow mask assembly decreases. However, even in such case, the short side mask frame members 11B bends such that the middle portion thereof protrudes upward, because of the bimetal structure of the short side mask frame members 11B. Therefore, the tension of the shadow mask 12 of the shadow mask assembly according to the present invention is substantially the same as that at a temperature of 25° C.

As mentioned above, in the shadow mask assembly 10 according to the first embodiment of the present invention, even when a temperature of the shadow mask assembly varies, the tension of the shadow mask 12 does not change. As a result thereof, the Q-value is kept constant, and color purity does not deteriorate. Therefore, the color cathode-ray tube which uses the shadow mask assembly 10 according to the first embodiment of the present invention always has good color purity.

The above-mentioned effect can also be obtained when the whole of the short side mask frame members 11B are made of Invar alloy. However, costs of such structure become high. On the other hand, in the present invention, costs is raised only by the band shaped members 11C, and total costs are much lower than the costs of the shadow mask assembly in which whole of the short side mask frame members 11b are made of Invar alloy. Therefore, the present invention provides a practically useful structure of the shadow mask assembly.

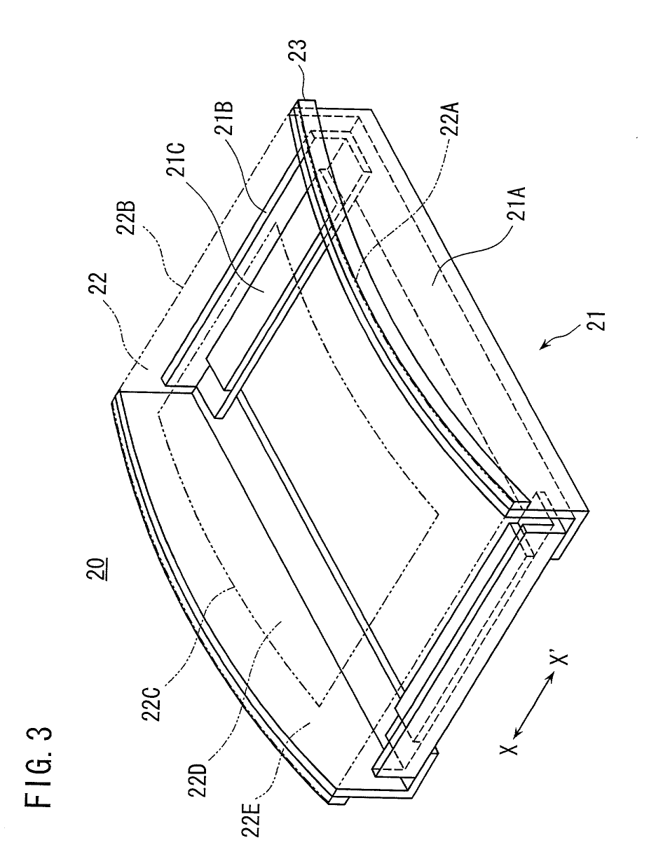

FIG. 3 is a perspective view showing a structure of a shadow mask assembly 20 according to the second embodiment of the present invention. The shadow mask assembly 20 according to the second embodiment of the present invention is also for use in a 19 inch type flat color cathode-ray tube. In FIG. 3, reference numeral 21 designates a mask frame which comprises a pair of long side mask frame members 21A and a pair of short side mask frame members 21B mutually coupled by welding and the like. Each of the long side mask frame members 21A and the short side mask frame members 21B is an elongated member having, for example, an L-shaped cross section as shown in FIG. 3. Each of the long side mask frame members 21A has an upper edge portion having an arc shape. A reference numeral 21C designates a band shaped member similar to that of the band shaped member 11C of the first embodiment. That is, the band shaped member 21C is made of Invar alloy having a thermal expansion coefficient smaller than that of 13 chromium stainless steel and is attached or stuck on the upper side, that is, on the side of the shadow mask 22, of each of the short side mask frame members 21B. Thereby, each of the short side mask frame members 21B has a bimetal structure. A reference numeral 22 designates a shadow mask. In FIG. 3, the shadow mask 22 is depicted only by using two dot chain lines showing long side edges 22A thereof, short side edges 22B thereof and a border line 22C between an area 22D in which holes or apertures are formed and a peripheral area 22E of the shadow mask 22. A reference numeral 23 designates a mask support member which is not included in the above-mentioned shadow mask assembly 10 according to the first embodiment of the present invention.

The shadow mask assembly 20 according to the second embodiment of the present invention differs from the shadow mask assembly 10 according to the first embodiment of the present invention in that, in the shadow mask assembly 20 according to the second embodiment of the present invention, both the long side mask frame members 21A and the short side mask frame members 21B are made of 13 chromium stainless steel. Also, the shadow mask assembly 20 has the above-mentioned pair of mask support members 23 attached to the long side mask frame members 21A. Each of the mask support members 23 is made of Invar alloy, and is 3 mm in thickness and 14 mm in width. It is preferable that the mask support members 23 are made of material having a thermal expansion coefficient which is approximately equal to that of the shadow mask 22. The upper edge portion of each of the mask support members 23 has an arc shape, and is coplanar with the upper edge portion of the corresponding long side mask frame member 21A. Preferably, each of the mask support members 23 is welded onto the corresponding long side mask frame member 21A, at the central portion of the mask support member 23. Further, in the shadow mask assembly 20 according to the second embodiment of the present invention, long sides 22A of the shadow mask 22 are seam-welded not onto the upper edge portions of the long side mask frame members 21A but onto the upper edge portions of the mask support members 23.

In the shadow mask assembly according to the second embodiment of the present invention, by using the above-mentioned structure, it is not necessary to match the thermal expansion coefficient of the long side mask frame members 21A with that of the shadow mask 22. Therefore, in this embodiment, the long side mask frame members 21A are made of 13 chromium stainless steel which is cheaper than the Invar alloy. Thus, even if costs for adding the mask support members 23 are taken into consideration, total costs of the shadow mask assembly 20 according to the second embodiment are much lower than those of the shadow mask assembly 10 according to the first embodiment. It is preferable to match the thermal expansion coefficient of the mask support members 23 with that of the shadow mask 22. Thereby, when temperature of the shadow mask assembly 20 varies, unnecessary deformation or distortion of the shadow mask 22 does not occur.

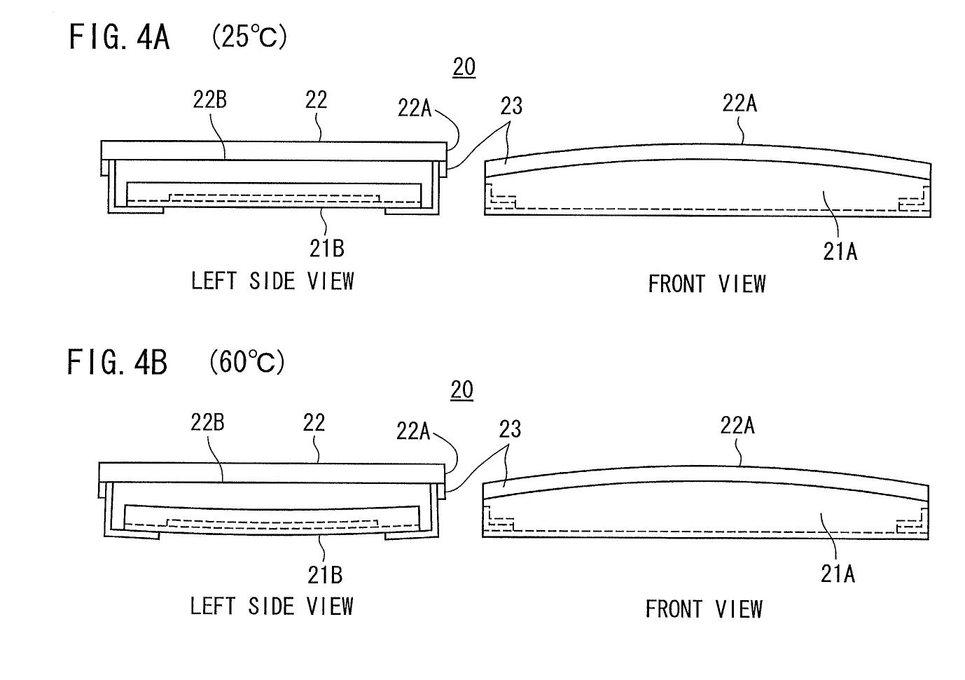

FIG. 4A and FIG. 4B schematically illustrate deformation of the mask frame 21 when the temperature of the shadow mask assembly 20 rises from 25 degrees Celsius to 60 degree Celsius. FIG. 4A shows the mask frame 21 at a temperature of 25° C. and FIG. 4B shows the mask frame 21 at a temperature of 60° C. As shown in FIG. 4A, the short side mask frame members 21B has a straight line shape at a temperature of 25° C. As shown in FIG. 4B, at a temperature of 60° C., the short side mask frame members 21B bends such that the middle portion thereof protrudes downward, because of the bimetal structure of the short side mask frame members 21B. As a result thereof, at a temperature of 60° C., the tension of the shadow mask 22 does not vary from the tension at 25° C., and therefore the shadow mask 22 does not deform from the original cylindrical surface. On the other hand, when the ambient temperature is relatively low, for example, when the color cathode-ray tube is used in the cold latitudes, if the temperature of the shadow mask assembly has fallen, for example, to 5° C., the tension of the shadow mask of the conventional shadow mask assembly decreases. However, even in such case, the short side mask frame members 21B bends such that the middle portion thereof protrudes upward, because of the bimetal structure of the short side mask frame members 21B. Therefore, the tension of the shadow mask 22 of the shadow mask assembly according to the present invention is substantially the same as that at a temperature of 25° C. As a result thereof, the Q-value is kept constant, and color purity does not deteriorate. Therefore, the color cathode-ray tube which uses the shadow mask assembly 20 according to the second embodiment of the present invention always has good color purity.

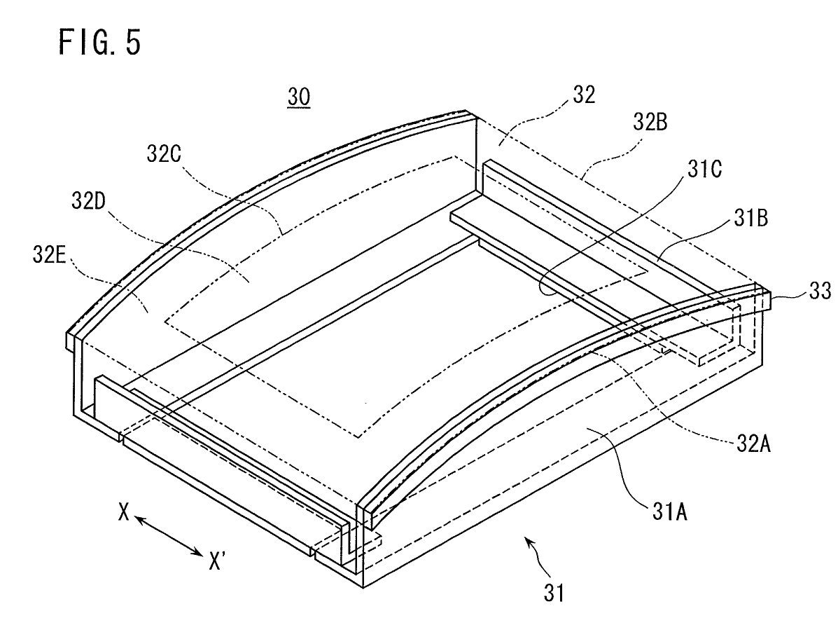

FIG. 5 is a perspective view showing a structure of a shadow mask assembly 30 according to the third embodiment of the present invention. In FIG. 5, reference numeral 31 designates a mask frame which comprises a pair-of long side mask frame members 31A and a pair of short side mask frame members 31B mutually coupled by welding and the like. Each of the long side mask frame members 31A and the short side mask frame members 31B is an elongated member having, for example, an L-shaped cross section as shown in FIG. 5. Each of the long side mask frame members 31A has an upper edge portion having an arc shape. A reference numeral 31C designates a band shaped member stuck on the lower side, that is, on the opposite side of the shadow mask 32, of each of the short side mask frame members 31B.

The band shaped member 31C has a thermal expansion coefficient larger than that of the short side mask frame members 31B and is made, for example, of 18-8 stainless steel. Thereby, each of the short side mask frame members 31B has a bimetal structure. A reference numeral 32 designates a shadow mask. In FIG. 5, the shadow mask 32 is depicted only by using two dot chain lines showing long side edges 32A thereof, short side edges 32B thereof and a border line 32C between an area 32D in which holes or apertures are formed and a peripheral area 32E of the shadow mask 32.

A reference numeral 33 designates a mask support member which is similar to the mask support member 23 of the second embodiment. The upper edge portion of each of the mask support members 33 has an arc shape, and is coplanar with the upper edge portion of the corresponding long side mask frame member 31A. Further, in the shadow mask assembly 30 according to the third embodiment of the present invention, long sides 32A of the shadow mask 32 are seam-welded not onto the upper edge portions of the long side mask frame members 31A but onto the upper edge portions of the mask support members 33. The other portion of the shadow mask assembly 30 according to the third embodiment is the same as that of the shadow mask assembly 20 according to the second embodiment.

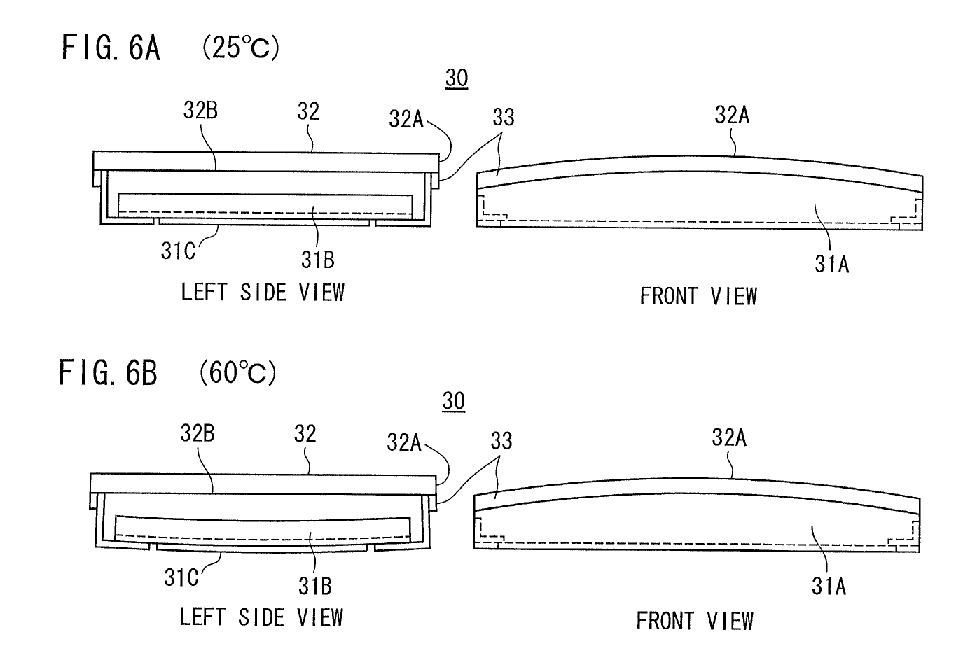

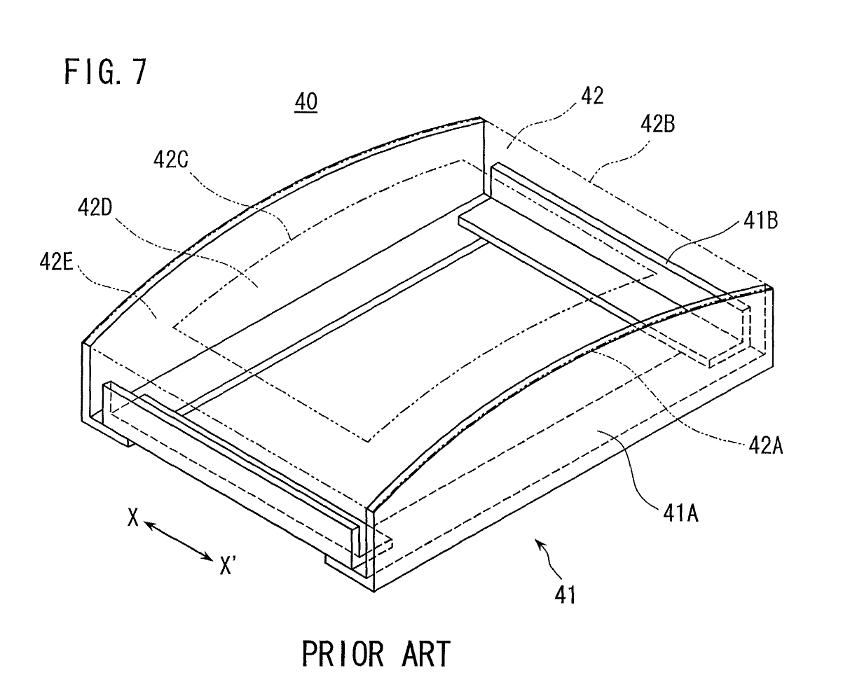

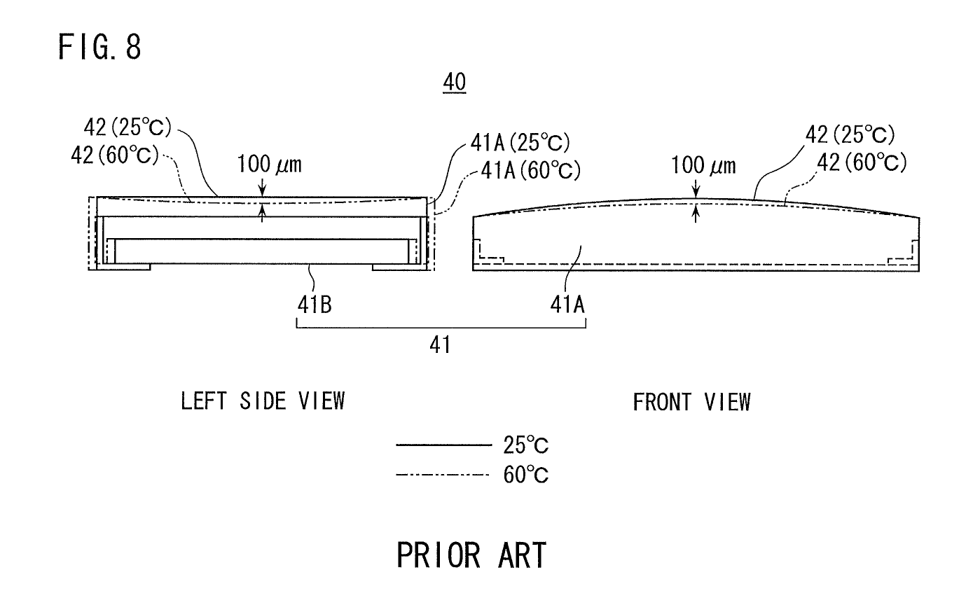

FIG. 6A and FIG. 6B schematically illustrate deformation of the mask frame 31 when the temperature of the shadow mask assembly 30 according to the third embodiment rises from 25 degrees Celsius to 60 degree Celsius. FIG. 6A shows the mask frame 31 at a temperature of 25° C. and FIG. 6B shows the mask frame 31 at a temperature of 60° C. As shown in FIG. 6A, the short side mask frame members 31B has a straight line shape at a temperature of 25° C. As shown in FIG. 6B, at a temperature of 60° C., the short side mask frame members 31B bends such that the middle portion thereof protrudes downward, because of the bimetal structure of the short side mask frame members 31B. As a result thereof, at a temperature of 60° C., the tension of the shadow mask 32 does not vary from the tension at 25° C., and therefore the shadow mask 32 does not deform from the original cylindrical surface. On the other hand, when the ambient temperature is relatively low, for example, when the color cathode-ray tube is used in the cold latitudes, if the temperature of the shadow mask assembly has fallen, for example, to 5° C., the short side mask frame members 31B bends such that the middle portion thereof protrudes upward, because of the bimetal structure of the short side mask frame members 31B. Therefore, the tension of the shadow mask 32 of the shadow mask assembly according to the present invention is substantially the same as that at a temperature of 25° C. As a result thereof, the Q-value is kept constant, and color purity does not deteriorate. Therefore, the color cathode-ray tube which uses the shadow mask assembly 30 according to the third embodiment of the present invention always has good color purity.

In the shadow mask assembly according to the present invention, the short side mask frame members have a bimetal structure which causes the short side mask frame members to bend according to variations in temperature. The direction of the bend of the short side mask frame members is selected such that, when the temperature of the shadow mask assembly rises, an increase in the tension of the shadow mask is cancelled and, when the temperature of the shadow mask assembly falls, a decrease in the tension of the shadow mask is cancelled.

By using such structure, even if the temperature rises and the short side mask frame members expand thereby, the tension of the shadow mask does not vary and therefore the shadow mask does not deform from the original cylindrical surface. On the other hand, when the ambient temperature is relatively low, for example, when the color cathode-ray tube is used in the cold latitudes, even if the temperature of the shadow mask assembly becomes relatively low, the tension of the shadow mask of the shadow mask assembly according to the present invention is substantially the same as before. As a result thereof, the Q-value is kept constant, and color purity does not deteriorate.

Therefore, the color cathode-ray tube which uses the shadow mask assembly according to the present invention always has good color purity.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative sense rather than a restrictive sense, and all such modifications are to be included within the scope of the present invention. Therefore, it is intended that this invention encompasses all of the variations and modifications as fall within the scope of the appended claims.

What is claimed is:

1. A shadow mask assembly comprising:
a mask frame which has a rectangular frame like shape and which is composed of a pair of short side mask frame members each having a bimetal structure which bends according to variations in temperature, and a pair of long side mask frame members; and
a shadow mask which has a rectangular shape and whose long sides are fixed to said mask frame;
wherein, when temperature rises, said short side mask frame members bend toward a direction in which an increase in the tension of said shadow mask is cancelled and, when temperature falls, said short side mask frame members bend toward another direction in which a decrease in the tension of said shadow mask is cancelled.

2. A shadow mask assembly as set forth in claim 1, wherein each of said short side mask frame members comprises an elongated member and a band shaped member which is attached onto said elongated member on the side of said shadow mask and which has a thermal expansion coefficient smaller than that of said elongated member.

3. A shadow mask assembly as set forth in claim 2, wherein said short side mask frame members are made of 13 chromium stainless steel.

4. A shadow mask assembly as set forth in claim 3, wherein said band shaped member is made of Invar alloy.

5. A shadow mask assembly as set forth in claim 1, wherein each of said short side mask frame members comprises an elongated member and a band shaped member which is attached onto said elongated member on the side opposite to said shadow mask and which has a thermal expansion coefficient larger than that of said elongated member.

6. A shadow mask assembly as set forth in claim 5, wherein said short side mask frame members are made of 13 chromium stainless steel.

7. A shadow mask assembly as set forth in claim 5, wherein said band shaped member is made of 18-8 stainless steel.

8. A shadow mask assembly as set forth in claim 1, wherein thermal expansion coefficient of said long side mask frame members is substantially equal to that of said shadow mask.

9. A shadow mask assembly as set forth in claim 1, wherein said shadow mask and said long side mask frame members are made of Invar alloy.

10. A shadow mask assembly comprising:
a mask frame which has a rectangular frame like shape and which is composed of a pair of short side mask frame members each having a bimetal structure which bends according to variations in temperature, and a pair of long side mask frame members each including an elongated member and a mask support member attached to said elongated member; and
a shadow mask which has a rectangular shape and whose long sides are fixed to said mask support members;
wherein, when temperature rises, said short side mask frame members bend toward a direction in which an increase in the tension of said shadow mask is cancelled and, when temperature falls, said short side mask frame members bend toward another direction in which a decrease in the tension of said shadow mask is cancelled.

11. A shadow mask assembly as set forth in claim 10, wherein each of said short side mask frame members comprises an elongated member and a band shaped member which is attached onto said elongated member on the side of said shadow mask and which has a thermal expansion coefficient smaller than that of said elongated member.

12. A shadow mask assembly as set forth in claim 10, wherein each of said short side mask frame members comprises an elongated member and a band shaped member which is attached onto said elongated member on the side opposite to said shadow mask and which has a thermal expansion coefficient larger than that of said elongated member.

13. A shadow mask assembly as set forth in claim 10, wherein thermal expansion coefficient of said mask support members is substantially equal to that of said shadow mask.

14. A shadow mask assembly as set forth in claim 10, wherein said shadow mask and said mask support members are made of Invar alloy.

15. A shadow mask assembly as set forth in claim 10, wherein said short side mask frame members and said long side mask frame members are made of 13 chromium stainless steel.

16. A shadow mask assembly as set forth in claim 10, wherein each of said mask support members is attached to the corresponding one of said long side mask frame members at the central portion of said mask support member.

17. A color cathode-ray tube including a shadow mask assembly as set forth in claim 1.

18. A color cathode-ray tube including a shadow mask assembly as set forth in claim 10.
